(19) United States
(12) Patent Application Publication
(10) Pub. No.: US 2006/0262116 A1
(43) Pub. Date: Nov. 23, 2006

(54) Global navigation objects in user interfaces

(75) Inventors: Negar Moshiri, Bethesda, MD (US); Frank J. Wroblewski, Gaithersburg, MD (US); William J. Napier, Germantown, MD (US); Frank A. Hunleth, Rockville, MD (US); Jason Witenstein-Weaver, Baltimore, MD (US)

Correspondence Address: POTOMAC PATENT GROUP, PLLC, P. O. BOX 270, FREDERICKSBURG, VA, 22404, US

(73) Assignee: Hillcrest Laboratories, Inc., Rockville, MD (US)

(21) Appl. No.: 11/437,215

(22) Filed: May 19, 2006

Related U.S. Application Data
(60) Provisional application No. 60/682,570, filed on May 19, 2005.
(60) Provisional application No. 60/683,005, filed on May 20, 2005.

(51) Int. Cl. G06T 15/00

(52) U.S. Cl. 345/419

(57) ABSTRACT

Systems and methods according to the present invention provide a user interface for interacting with user interface (UI) objects including global navigation objects.

### RELATED APPLICATIONS

This application is related to, and claims priority from, U.S. Provisional Patent Application Ser. No. 60/682,570 filed on May 19, 2005, entitled “Free Space Navigation in the Channel-less World Without Up/Down/Left/Right” to Negar Moshiri et al. and U.S. Provisional Patent Application Ser. No. 60/683,005 filed on May 20, 2005, entitled “Control Framework with a Zoomable Graphical User Interface for Organizing, Selecting and Launching Media Items” to Frank A. Hunleth et al., the disclosures of which are incorporated here by reference.

### BACKGROUND

This application describes, among other things, global navigation objects employed in user interfaces.

Technologies associated with the communication of information have evolved rapidly over the last several decades. Television, cellular telephony, the Internet and optical communication techniques (to name just a few things) combine to inundate consumers with available information and entertainment options. Taking television as an example, the last three decades have seen the introduction of cable television service, satellite television service, pay-per-view movies and video-on-demand. Whereas television viewers of the 1960s could typically receive perhaps four or five over-the-air TV channels on their television sets, today's TV watchers have the opportunity to select from hundreds, thousands, and potentially millions of channels of shows and information. Video-on-demand technology, currently used primarily in hotels and the like, provides the potential for in-home entertainment selection from among thousands of movie titles.

The technological ability to provide so much information and content to end users provides both opportunities and challenges to system designers and service providers. One challenge is that while end users typically prefer having more choices rather than fewer, this preference is counterweighted by their desire that the selection process be both fast and simple. Unfortunately, the development of the systems and interfaces by which end users access media items has resulted in selection processes which are neither fast nor simple. Consider again the example of television programs. When television was in its infancy, determining which program to watch was a relatively simple process primarily due to the small number of choices. One would consult a printed guide which was formatted, for example, as series of columns and rows which showed the correspondence between (1) nearby television channels, (2) programs being transmitted on those channels and (3) date and time. The television was tuned to the desired channel by adjusting a tuner knob and the viewer watched the selected program. Later, remote control devices were introduced that permitted viewers to tune the television from a distance. This addition to the user-television interface created the phenomenon known as “channel surfing” whereby a viewer could rapidly view short segments being broadcast on a number of channels to quickly learn what programs were available at any given time.

Despite the fact that the number of channels and amount of viewable content has dramatically increased, the generally available user interface, control device options and frameworks for televisions has not changed much over the last 30 years. Printed guides are still the most prevalent mechanism for conveying programming information. The multiple button remote control with up and down arrows is still the most prevalent channel/content selection mechanism. The reaction of those who design and implement the TV user interface to the increase in available media content has been a straightforward extension of the existing selection procedures and interface objects. Thus, the number of rows in the printed guides has been increased to accommodate more channels. The number of buttons on the remote control devices has been increased to support additional functionality and content handling, e.g., as shown in FIG. 1. However, this approach has significantly increased both the time required for a viewer to review the available information and the complexity of actions required to implement a selection. Arguably, the cumbersome nature of the existing interface has hampered commercial implementation of some services, e.g., video-on-demand, since consumers are resistant to new services that will add complexity to an interface that they view as already too slow and complex.

In addition to increases in bandwidth and content, the user interface bottleneck problem is being exacerbated by the aggregation of technologies. Consumers are reacting positively to having the option of buying integrated systems rather than a number of segregable components. An example of this trend is the combination television/VCR/DVD in which three previously independent components are frequently sold today as an integrated unit. This trend is likely to continue, potentially with an end result that most if not all of the communication devices currently found in the household will be packaged together as an integrated unit, e.g., a television/VCR/DVD/internet access/radio/stereo unit. Even those who continue to buy separate components will likely desire seamless control of, and interworking between, the separate components. With this increased aggregation comes the potential for more complexity in the user interface. For example, when so-called “universal” remote units were introduced, e.g., to combine the functionality of TV remote units and VCR remote units, the number of buttons on these universal remote units was typically more than the number of buttons on either the TV remote unit or VCR remote unit individually. This added number of buttons and functionality makes it very difficult to control anything but the simplest aspects of a TV or VCR without hunting for exactly the right button on the remote. Many times, these universal remotes do not provide enough buttons to access many levels of control or features unique to certain TVs. In these cases, the original device remote unit is still needed, and the original hassle of handling multiple remotes remains due to user interface issues arising from the complexity of aggregation. Some remote units have addressed this problem by adding “soft” buttons that can be programmed with the expert commands. These soft buttons sometimes have accompanying LCD displays to indicate their action. These too have the flaw that they are difficult to use without looking away from the TV to the remote control. Yet another flaw in these remote units is the use of modes in an attempt to reduce the number of buttons. In these “moded” universal remote units, a special button exists to select whether the remote should communicate with the TV, DVD player, cable set-top box, VCR, etc. This causes many usability issues including sending commands to the wrong device, forcing the user to look at the remote to make sure that it is in the right mode, and it does not provide any simplification to the integration of multiple devices. The most advanced of these universal remote units provide some integration by allowing the user to program sequences of commands to multiple devices into the remote. This is such a difficult task that many users hire professional installers to program their universal remote units.

Some attempts have also been made to modernize the screen interface between end users and media systems. However, these attempts typically suffer from, among other drawbacks, an inability to easily scale between large collections of media items and small collections of media items. For example, interfaces which rely on lists of items may work well for small collections of media items, but are tedious to browse for large collections of media items. Interfaces which rely on hierarchical navigation (e.g., tree structures) may be speedier to traverse than list interfaces for large collections of media items, but are not readily adaptable to small collections of media items. Additionally, users tend to lose interest in selection processes wherein the user has to move through three or more layers in a tree structure. For all of these cases, current remote units make this selection process even more tedious by forcing the user to repeatedly depress the up and down buttons to navigate the list or hierarchies. When selection skipping controls are available such as page up and page down, the user usually has to look at the remote to find these special buttons or be trained to know that they even exist. Accordingly, organizing frameworks, techniques and systems which simplify the control and screen interface between users and media systems as well as accelerate the selection process, while at the same time permitting service providers to take advantage of the increases in available bandwidth to end user equipment by facilitating the supply of a large number of media items and new services to the user have been proposed in U.S. patent application Ser. No. 10/768,432, filed on Jan. 30, 2004, entitled “A Control Framework with a Zoomable Graphical User Interface for Organizing, Selecting and Launching Media Items”, the disclosure of which is incorporated here by reference.

Of particular interest for this specification are the remote devices usable to interact with such frameworks, as well as other applications, systems and methods for these remote devices for interacting with such frameworks. As mentioned in the above-incorporated application, various different types of remote devices can be used with such frameworks including, for example, trackballs, “mouse”-type pointing devices, light pens, etc. However, another category of remote devices which can be used with such frameworks (and other applications) is 3D pointing devices with scroll wheels. The phrase “3D pointing” is used in this specification to refer to the ability of an input device to move in three (or more) dimensions in the air in front of, e.g., a display screen, and the corresponding ability of the user interface to translate those motions directly into user interface commands, e.g., movement of a cursor on the display screen. The transfer of data between the 3D pointing device may be performed wirelessly or via a wire connecting the 3D pointing device to another device. Thus “3D pointing” differs from, e.g., conventional computer mouse pointing techniques which use a surface, e.g., a desk surface or mousepad, as a proxy surface from which relative movement of the mouse is translated into cursor movement on the computer display screen. An example of a 3D pointing device can be found in U.S. patent application Ser. No. 11/119,663, the disclosure of which is incorporated here by reference.

### SUMMARY

Systems and methods according an exemplary embodiment of the present invention provide a user interface for manipulating media items on a television comprising a plurality of different user interface (UI) views, each of which can be displayed on the television, wherein each of the plurality of different UI views displays a different set of UI objects associated with the media items, which UI objects can be selected by user interaction with the user interface; and a plurality of global navigation objects, at least a subset of which are substantially identically displayed on substantially every UI view displayed by the user interface.

According to another exemplary embodiment of the present invention, a user interface for interacting with user interface (UI) objects on a display includes a plurality of different UI views, each of which can be displayed on the display, wherein each of the plurality of different UI views displays a different set of the UI objects, which UI objects can be selected by user interaction with the user interface; and a plurality of global navigation objects, at least a subset of which are substantially identically displayed on substantially every UI view displayed by the user interface.

According to another exemplary embodiment of the present invention, a method for displaying media items in a user interface includes the steps of: displaying a plurality of different user interface (UI) views; wherein each of the plurality of different UI views displays a different set of UI objects associated with the media items, which UI objects can be selected by user interaction with the user interface, and displaying a plurality of global navigation objects, at least a subset of which are substantially identically displayed on substantially every UI view displayed by the user interface, wherein each of the plurality of global navigation objects have at least three display states: a watermark state, an over state and a non-displayed state; wherein in the watermark state, which is a default display state, each of the global navigation objects are displayed to be partially visible; wherein in the over state, which is triggered by presence of a cursor proximate or over one of the global navigation objects, the one of the global navigation objects becomes fully visible; and wherein in the non-displayed state, the global navigation objects are removed from display in a current UI view.

According to another exemplary embodiment of the present invention, a user interface for manipulating media items on a television includes a plurality of different user interface (UI) views, each of which can be displayed on the television; wherein each of the plurality of different UI views displays a different set of UI objects associated with the media items, which UI objects can be selected by user interaction with the user interface, and a plurality of global navigation objects, at least a subset of which are substantially identically displayed on substantially every UI view displayed by the user interface, wherein each of the plurality of global navigation objects have at least three display states: a watermark state, an over state and a non-displayed state; wherein in the watermark state, which is a default display state, each of the global navigation objects are displayed to be partially visible, wherein in the over state, which is triggered by presence of a cursor proximate or over one of the global navigation objects, the one of the global navigation objects becomes fully visible; and wherein in the non-displayed state, the global navigation objects are removed from display in a current UI view.

### BRIEF DESCRIPTION OF THE DRAWINGS

The accompanying drawings illustrate exemplary embodiments of the present invention, wherein:

FIG. 1 depicts a conventional remote control unit for an entertainment system;

FIG. 2 depicts an exemplary media system in which exemplary embodiments of the present invention can be implemented;

FIG. 3(a) shows a 3D pointing device according to an exemplary embodiment of the present invention;

FIG. 3(b) illustrates a user employing a 3D pointing device to provide input to a user interface on a television according to an exemplary embodiment of the present invention;

FIG. 4 shows the global navigation objects of FIG. 3(b) in more detail according to an exemplary embodiment of the present invention;

FIG. 5 depicts a zooming transition as well as a usage of an up function global navigation object according to an exemplary embodiment of the present invention;

FIG. 6 shows a search tool which can be displayed as a result of actuation of a search global navigation object according to an exemplary embodiment of the present invention;

FIG. 7 shows a live TV UI view which can be reach via actuation of a live TV global navigation object according to an exemplary embodiment of the present invention;

FIGS. 8 and 9 depict channel changing and volume control overlays which can be rendered visible on the live TV UI view of FIG. 7 according to an exemplary embodiment of the present invention; and

FIG. 10 shows an electronic program guide view having global navigation objects according to an exemplary embodiment of the present invention.

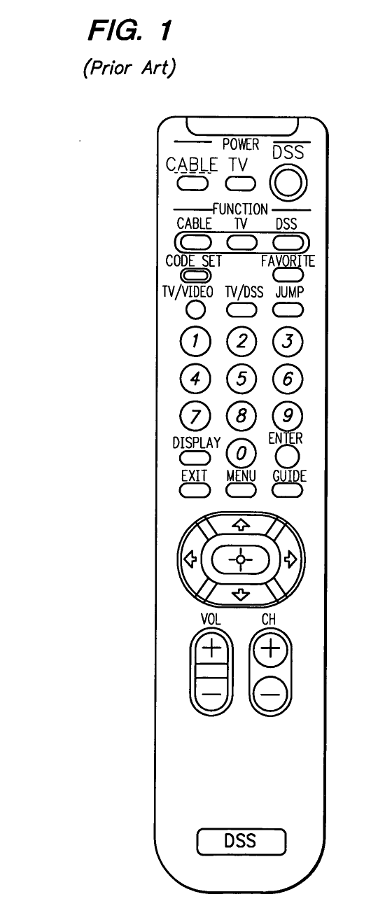

### DETAILED DESCRIPTION

The following detailed description of the invention refers to the accompanying drawings. The same reference numbers in different drawings identify the same or similar elements. Also, the following detailed description does not limit the invention. Instead, the scope of the invention is defined by the appended claims.

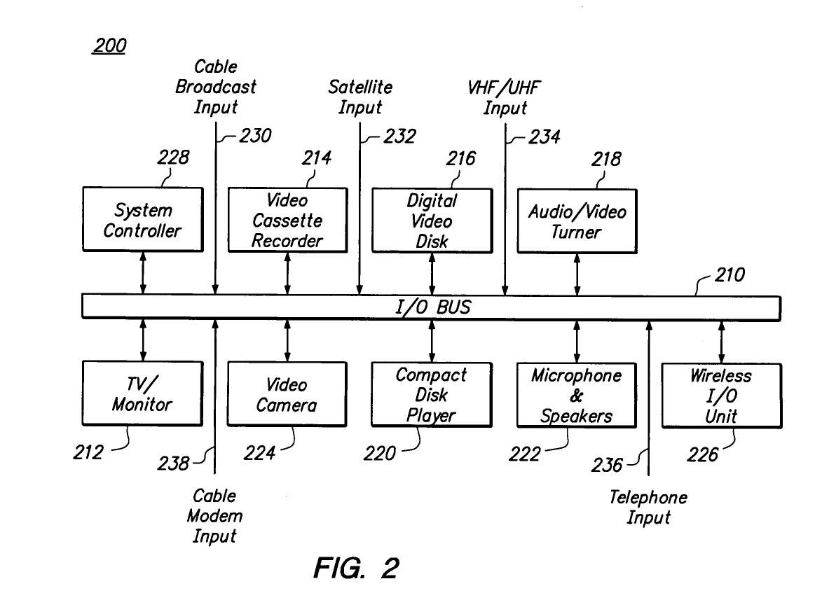

In order to provide some context for this discussion, an exemplary aggregated media system 200 in which the present invention can be implemented will first be described with respect to FIG. 2. Those skilled in the art will appreciate, however, that the present invention is not restricted to implementation in this type of media system and that more or fewer components can be included therein. Therein, an input/output (I/O) bus 210 connects the system components in the media system 200 together. The I/O bus 210 represents any of a number of different of mechanisms and techniques for routing signals between the media system components. For example, the I/O bus 210 may include an appropriate number of independent audio “patch” cables that route audio signals, coaxial cables that route video signals, two-wire serial lines or infrared or radio frequency transceivers that route control signals, optical fiber or any other routing mechanisms that route other types of signals.

In this exemplary embodiment, the media system 200 includes a television/monitor 212, a video cassette recorder (VCR) 214, digital video disk (DVD) recorder/playback device 216, audio/video tuner 218 and compact disk player 220 coupled to the I/O bus 210. The VCR 214, DVD 216 and compact disk player 220 may be single disk or single cassette devices, or alternatively may be multiple disk or multiple cassette devices. They may be independent units or integrated together. In addition, the media system 200 includes a microphone/speaker system 222, video camera 224 and a wireless I/O control device 226. According to exemplary embodiments of the present invention, the wireless I/O control device 226 is a 3D pointing device. The wireless I/O control device 226 can communicate with the entertainment system 200 using, e.g., an IR or RF transmitter or transceiver. Alternatively, the I/O control device can be connected to the entertainment system 200 via a wire.

The entertainment system 200 also includes a system controller 228. According to one exemplary embodiment of the present invention, the system controller 228 operates to store and display entertainment system data available from a plurality of entertainment system data sources and to control a wide variety of features associated with each of the system components. As shown in FIG. 2, system controller 228 is coupled, either directly or indirectly, to each of the system components, as necessary, through I/O bus 210. In one exemplary embodiment, in addition to or in place of I/O bus 210, system controller 228 is configured with a wireless communication transmitter (or transceiver), which is capable of communicating with the system components via IR signals or RF signals. Regardless of the control medium, the system controller 228 is configured to control the media components of the media system 200 via a graphical user interface described below.

As further illustrated in FIG. 2, media system 200 may be configured to receive media items from various media sources and service providers. In this exemplary embodiment, media system 200 receives media input from and, optionally, sends information to, any or all of the following sources: cable broadcast 230, satellite broadcast 232 (e.g., via a satellite dish), very high frequency (VHF) or ultra high frequency (UHF) radio frequency communication of the broadcast television networks 234 (e.g., via an aerial antenna), telephone network 236 and cable modem 238 (or another source of Internet content). Those skilled in the art will appreciate that the media components and media sources illustrated and described with respect to FIG. 2 are purely exemplary and that media system 200 may include more or fewer of both. For example, other types of inputs to the system include AM/FM radio and satellite radio.

More details regarding this exemplary entertainment system and frameworks associated therewith can be found in the above-incorporated by reference U.S. Patent Application “A Control Framework with a Zoomable Graphical User Interface for Organizing, Selecting and Launching Media Items”. Alternatively, remote devices and interaction techniques between remote devices and user interfaces in accordance with the present invention can be used in conjunction with other types of systems, for example computer systems including, e.g., a display, a processor and a memory system or with various other systems and applications.

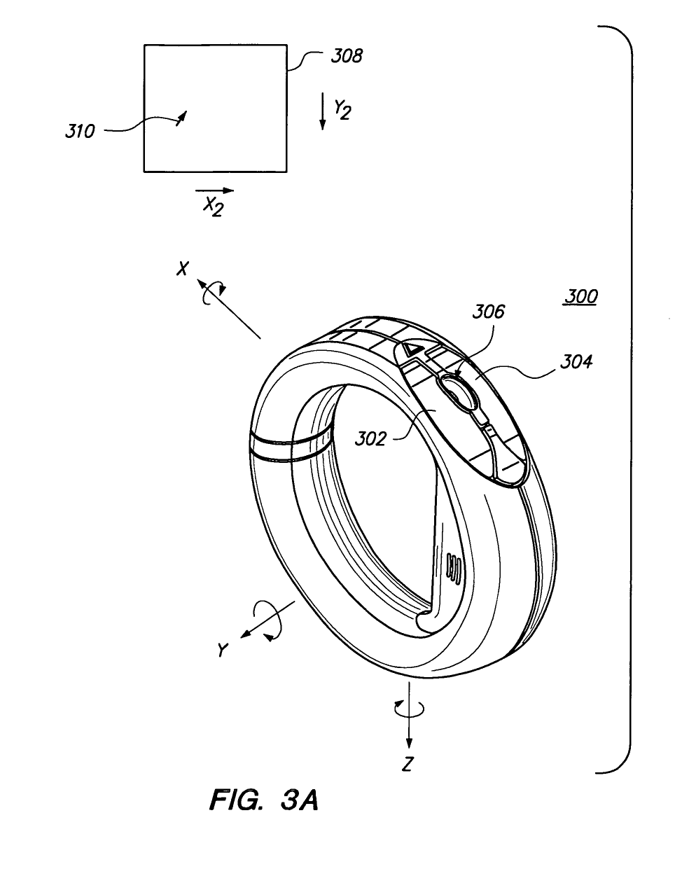

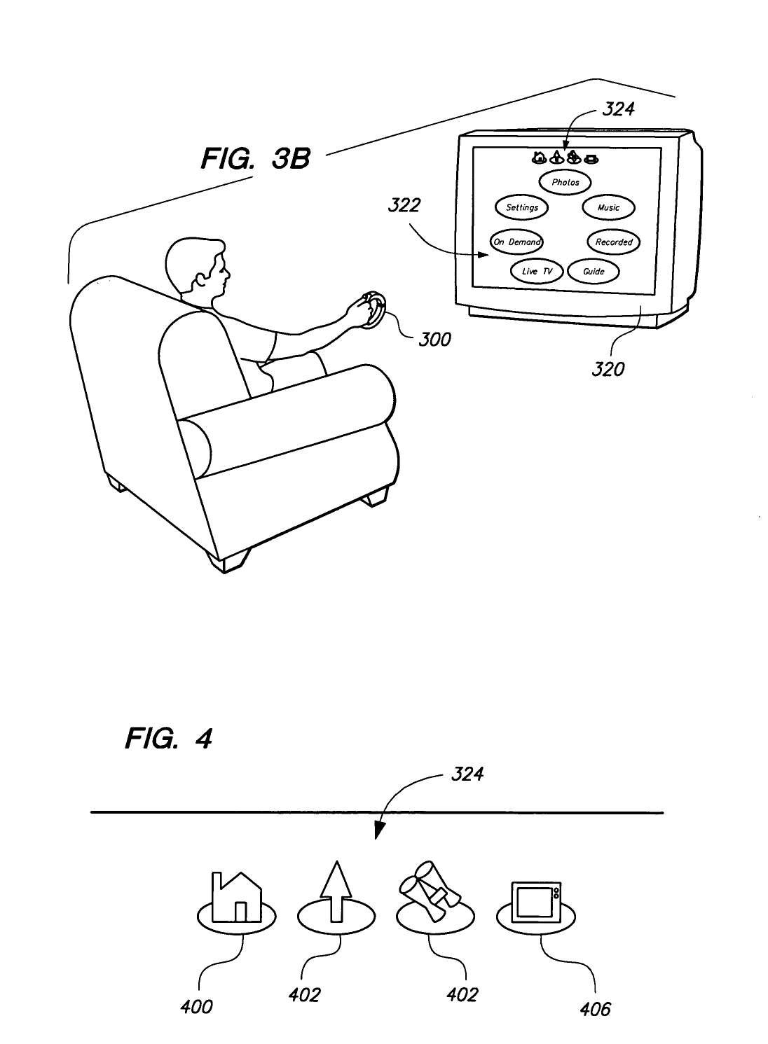

As mentioned in the Background section, remote devices which operate as 3D pointers are of particular interest for the present specification, although the present invention is not limited to systems including 3D pointers. Such devices enable the translation of movement of the device, e.g., linear movement, rotational movement, acceleration or any combination thereof, into commands to a user interface. An exemplary loop-shaped, 3D pointing device 300 is depicted in FIG. 3(a), however the present invention is not limited to loop-shaped devices. In this exemplary embodiment, the 3D pointing device 300 includes two buttons 302 and 304 as well as a scroll wheel 306 (scroll wheel 306 can also act as a button by depressing the scroll wheel 306), although other exemplary embodiments will include other physical configurations. User movement of the 3D pointing device 300 can be defined, for example, in terms of rotation about one or more of an x-axis attitude (roll), a y-axis elevation (pitch) or a z-axis heading (yaw). In addition, some exemplary embodiments of the present invention can additionally (or alternatively) measure linear movement of the 3D pointing device 300 along the x, y, and/or z axes to generate cursor movement or other user interface commands. An example is provided below. A number of permutations and variations relating to 3D pointing devices can be implemented in systems according to exemplary embodiments of the present invention. The interested reader is referred to U.S. patent application Ser. No. 11/119,663, entitled (as amended) “3D Pointing Devices and Methods”, filed on May 2, 2005, U.S. patent application Ser. No. 11/119,719, entitled (as amended) “3D Pointing Devices with Tilt Compensation and Improved Usability”, also filed on May 2, 2005, U.S. patent application Ser. No. 11/119,987, entitled (as amended) “Methods and Devices for Removing Unintentional Movement in 3D Pointing Devices”, also filed on May 2, 2005, and U.S. patent application Ser. No. 11/119,688, entitled “Methods and Devices for Identifying Users Based on Tremor”, also filed on May 2, 2005, the disclosures of which are incorporated here by reference, for more details regarding exemplary 3D pointing devices which can be used in conjunction with exemplary embodiments of the present invention.

According to exemplary embodiments of the present invention, it is anticipated that 3D pointing devices 300 will be held by a user in front of a display 308 and that motion of the 3D pointing device 300 will be translated by the 3D pointing device into output which is usable to interact with the information displayed on display 308, e.g., to move the cursor 310 on the display 308. For example, such 3D pointing devices and their associated user interfaces can be used to make media selections on a television as shown in FIG. 3(b), which will be described in more detail below. Aspects of exemplary embodiments of the present invention can be optimized to enhance the user's experience of the so-called “10-foot” interface, i.e., a typical distance between a user and his or her television in a living room. For example, interactions between pointing, scrolling, zooming and panning, e.g., using a 3D pointing device and associated user interface, can be optimized for this environment as will be described below, although the present invention is not limited thereto.

Referring again to FIG. 3(a), an exemplary relationship between movement of the 3D pointing device 300 and corresponding cursor movement on a user interface will now be described. Rotation of the 3D pointing device 300 about the y-axis can be sensed by the 3D pointing device 300 and translated into an output usable by the system to move cursor 310 along the y₂ axis of the display 308. Likewise, rotation of the 3D pointing device 308 about the z-axis can be sensed by the 3D pointing device 300 and translated into an output usable by the system to move cursor 310 along the x₂ axis of the display 308. It will be appreciated that the output of 3D pointing device 300 can be used to interact with the display 308 in a number of ways other than (or in addition to) cursor movement, for example it can control cursor fading, volume or media transport (play, pause, fast-forward and rewind). Additionally, the system can be programmed to recognize gestures, e.g., predetermined movement patterns, to convey commands in addition to cursor movement. Moreover, other input commands, e.g., a zoom-in or zoom-out on a particular region of a display (e.g., actuated by pressing button 302 to zoom-in or button 304 to zoom-out), may also be available to the user.

Returning now to the application illustrated in FIG. 3(b), the GUI screen (also referred to herein as a “UI view”, which terms refer to a currently displayed set of UI objects) seen on television 320 is a home view. In this particular exemplary embodiment, the home view displays a plurality of applications 322, e.g., “Photos”, “Music”, “Recorded”, “Guide”, “Live TV”, “On Demand”, and “Settings”, which are selectable by the user by way of interaction with the user interface via the 3D pointing device 300. Such user interactions can include, for example, pointing, scrolling, clicking or various combinations thereof. For more details regarding exemplary pointing, scrolling and clicking interactions which can be used in conjunction with exemplary embodiments of the present invention, the interested reader is directed to U.S. patent application Ser. No. ______, entitled “METHODS AND SYSTEMS FOR SCROLLING AND POINTING IN USER INTERFACE”, to Frank J. Wroblewski, filed on May 4, 2006, the disclosure of which is incorporated here by reference.

Of particular interest for exemplary embodiments of the present invention are the global navigation objects 324 displayed above the UI objects 322 that are associated with various media applications. Global navigation objects 324 provide short cuts to significant applications, frequently used UI views or the like, without cluttering up the interface and in a manner which is consistent with other aspects of the particular user interface in which they are implemented. Initially some functional examples will be described below, followed by some more general characteristics of global navigation objects according to exemplary embodiments of the present invention.

Although the global navigation objects 324 are displayed in FIG. 3(b) simply as small circles, in actual implementations they will typically convey information regarding their functionality to a user by including an icon, image, text or some combination thereof as part of their individual object displays on the user interface. A purely illustrative example is shown in FIG. 4. Therein, four global navigation objects 400-406 are illustrated. The leftmost global navigation object 400 operates to provide the user with a shortcut to quickly reach a home UI view (main menu). For example, the user can move the 3D pointing device 300 in a manner which will position a cursor (not shown) over the global navigation object 400. Then, by selecting the global navigation object 400, the user interface will immediately display the home view, e.g., the view shown in FIG. 3(b). Other mechanisms can be used to select and actuate the global navigation object 400, as well as the other global navigation objects generally referenced by 324. For example, as described in the above-identified patent application entitled “METHODS AND SYSTEMS FOR SCROLLING AND POINTING IN USER INTERFACE”, to Frank J. Wroblewski, each of the global navigation objects 324 can also be reached by scrolling according to one exemplary embodiment of the present invention.

The other global navigation objects 402 through 406 similarly provide shortcut access to various UI views and/or functionality. For example, global navigation object 402 is an “up” global navigation object. Actuation of this global navigation object will result in the user interface displaying a next “highest” user interface view relative to the currently displayed user interface view. The relationship between a currently displayed user interface view and its next “highest” user interface view will depend upon the particular user interface implementation. According to exemplary embodiments of the present invention, user interfaces may use, at least in part, zooming techniques for moving between user interface views. In the context of such user interfaces, the next “highest” user interface view that will be reached by actuating global navigation object 402 is the UI view which is one zoom level higher than the currently displayed UI view. Thus, actuation of the global navigation object 402 will result in a transition from a currently displayed UI view to a zoomed out UI view which can be displayed along with a zooming transition effect. The zooming transition effect can be performed by progressive scaling and displaying of at least some of the UI objects displayed on the current UI view to provide a visual impression of movement of those UI objects away from an observer. In another functional aspect of the present invention, user interfaces may zoom-in in response to user interaction with the user interface which will, likewise, result in the progressive scaling and display of UI objects that provide the visual impression of movement toward an observer. More information relating to zoomable user interfaces can be found in U.S. patent application Ser. No. 10/768,432, filed on Jan. 30, 2004, entitled “A Control Framework with a Zoomable Graphical User Interface for Organizing, Selecting and Launching Media Items”, and U.S. patent application Ser. No. 09/829,263, filed on Apr. 9, 2001, entitled “Interactive Content Guide for Television Programming”, the disclosures of which are incorporated here by reference.

Movement within the user interface between different user interface views is not limited to zooming. Other non-zooming techniques can be used to transition between user interface views. For example, panning can be performed by progressive translation and display of at least some of the user interface objects which are currently displayed in a user interface view. This provides the visual impression of lateral movement of those user interface objects to an observer.

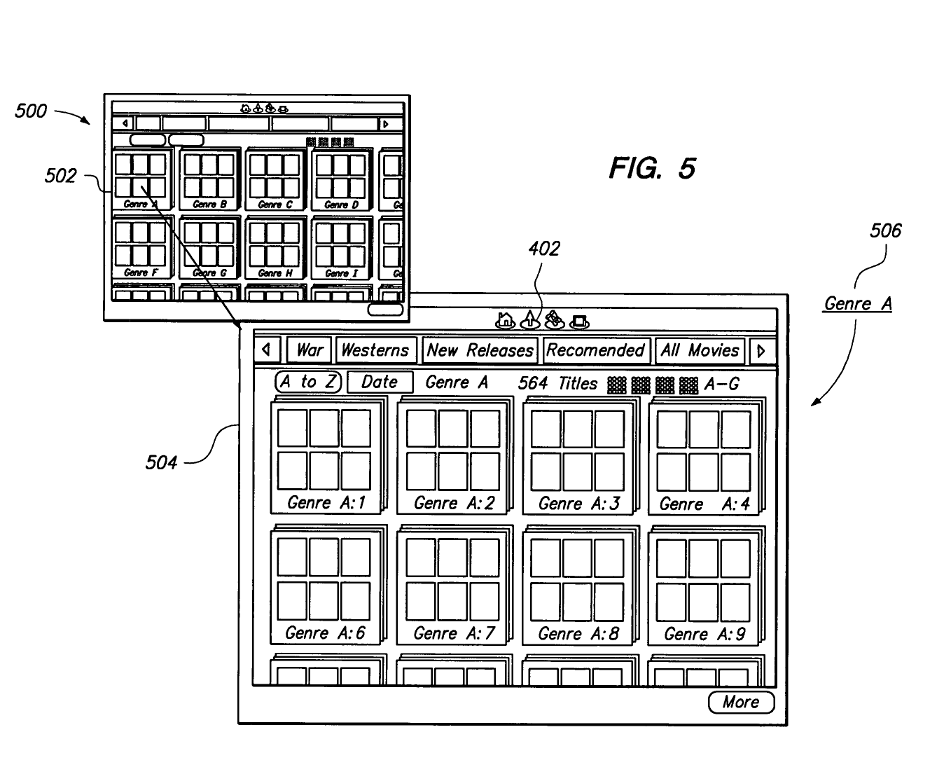

Regardless of the different techniques which are employed in a particular user interface implementation to transition between user interface views, the provision of a global navigation object 402 which provides an up function may be particularly beneficial for user interfaces in which there are multiple paths available for a user to reach the same UI view. For example, consider the UI view 500 shown in FIG. 5. This view illustrates a number of on-demand movie selections, categorized by genre, which view 500 can be reached by, for example, zooming in on the “On Demand” application object shown in the home view of FIG. 3(b). By pressing the zoom-in button 302 on the 3D pointing device 300 one more time, while the current focus (e.g., selection highlighting) is on the UI object associated with “Genre A” 502 in the UI view 500, the user interface will zoom-in on this object to display a new UI view 504. The UI view 504 will display a number of sub-genre media selection objects which can, for example, be implemented as DVD movie cover images. However, this same UI view 504 could also have been reached by following a different path through the user interface, e.g., by actuating a hyperlink 506 from another UI view. Under this scenario, actuating the up global navigation object 402 from UI view 504 will always result in the user interface displaying UI view 502, regardless of which path the user employed to navigate to UI view 504 in the first place. By way of contrast, if the user actuates the zoom-out (or back) button 304 from UI view 504, the user interface will display the previous UI view along the path taken by the user to reach UI view 504. Thus, according to this exemplary embodiment of the present invention, the up global navigation object 504 provides a consistent mechanism for the user to move to a next “highest” level of the interface, while the zoom-out (or back) button 304 on the 3D pointing device 300 provides a consistent mechanism for the user to retrace his or her path through the interface.

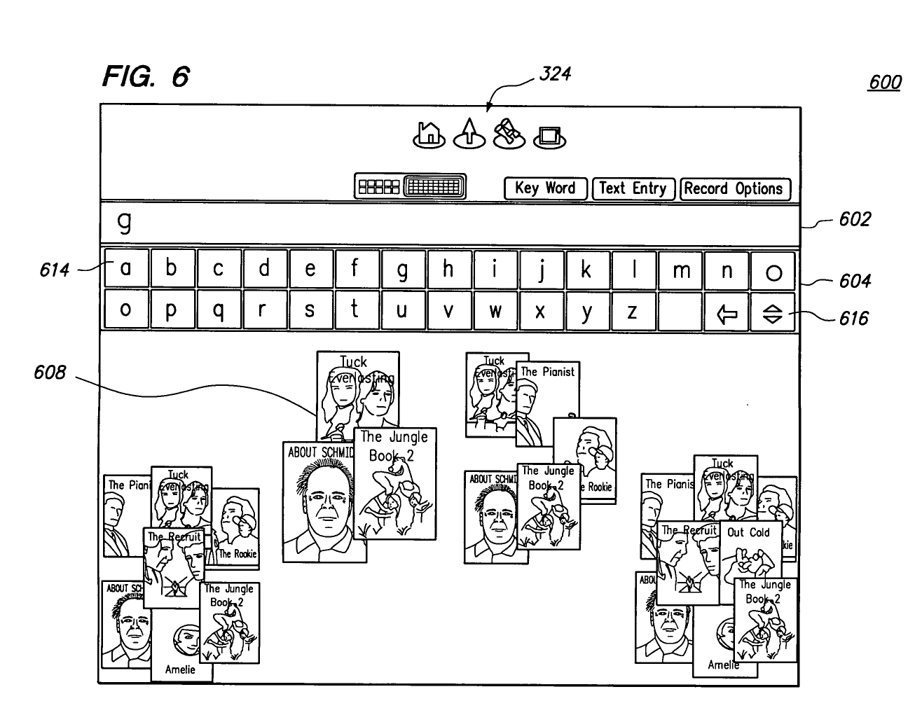

Returning to FIG. 4, global navigation object 404 provides a search function when activated by a user. As a purely illustrative example, the search tool depicted in FIG. 6 can be displayed when a user actuates the global navigation object 404 from any of the UI views within the user interface on which global navigation object 404 is displayed. The exemplary UI view 600 depicted in FIG. 6 contains a text entry widget including a plurality of control elements 604, with at least some of the control elements 604 being drawn as keys or buttons having alphanumeric characters 614 thereon, and other control elements 604 being drawn on the interface as having non-alphanumeric characters 616 which can be, e.g., used to control character entry. In this example, the control elements 604 are laid out in two horizontal rows across the interface, although other configurations may be used.

Upon actuating a control element 604, e.g., by clicking a button on a the 3D pointing device 300 when a particular element 604 has the focus, the corresponding alphanumeric input is displayed in the textbox 602, disposed above the text entry widget, and one or more groups of displayed items related to the alphanumeric input provided via the control element(s) can be displayed on the interface, e.g., below the text entry widget. Thus, the GUI screen depicted in FIG. 6 according to one exemplary embodiment of the present invention can be used to search for selectable media items, and graphically display the results of the search on a GUI screen, in a manner that is useful, efficient and pleasing to the user. (Note that in the illustrated example of FIG. 6, although the letter “g” is illustrated as being displayed in the text box 602, the displayed movie cover images below the text entry widget simply represent a test pattern of DVD movie covers and are not necessarily related to the input letter “g” as they could be in an implementation, e.g., the displayed movie covers could be only those whose movie titles start with the letter “g”). This type of search tool enables a user to employ both keyword searching and visual browsing in a powerful combination that expedites a search across, potentially, thousands of selectable media items. By selecting one of the DVD movie covers, e.g., UI object 608, the user interface can, for example, display a more detailed UI view associated with that movie, along with an option for a user to purchase and view that on-demand movie. As those skilled in the art will appreciate, given a potentially very large number of selectable media items, quick and easy access to a search tool made possible by the provision of global navigation object 404 on most, if not all, of the UI views provided by the user interface, provides the user with convenient access thereto.

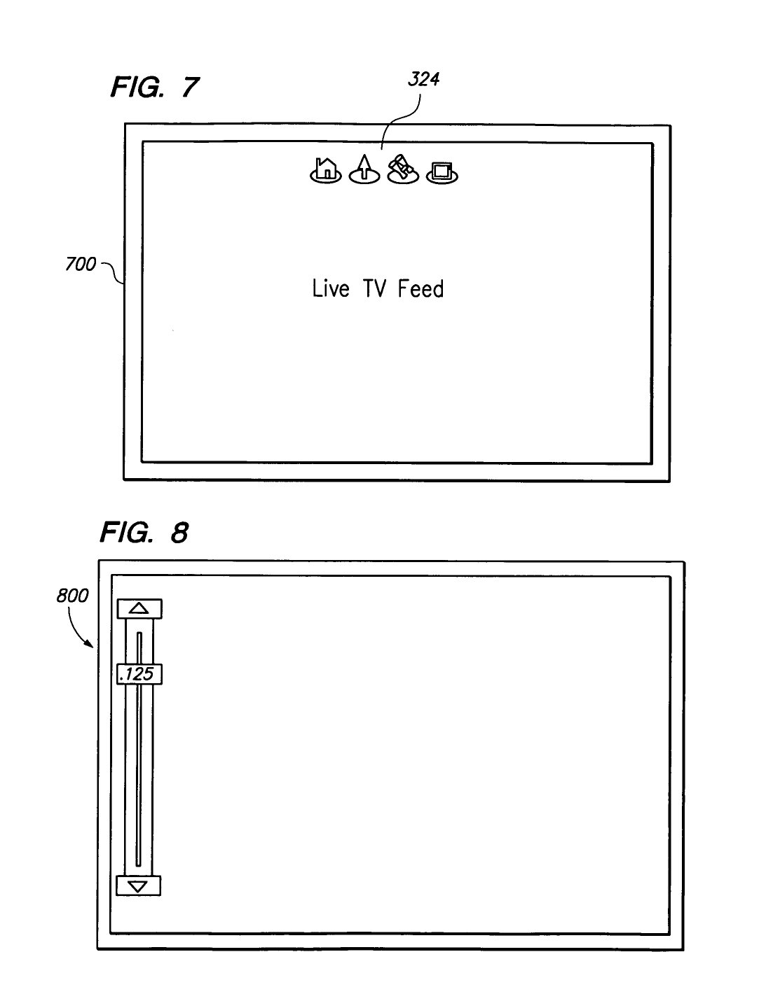

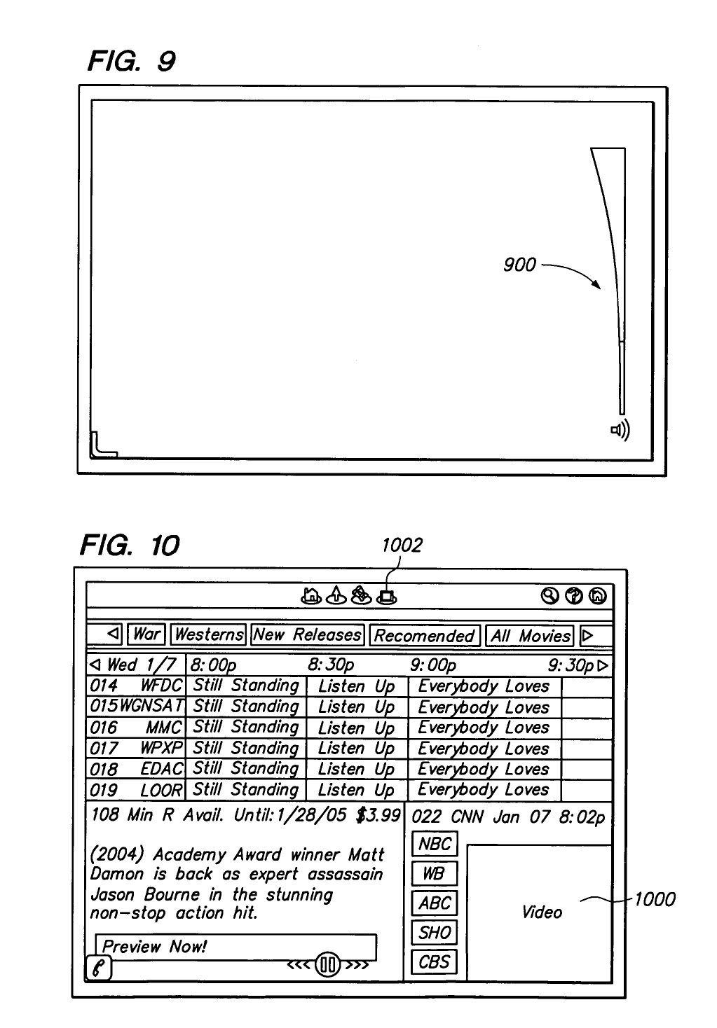

Returning again to FIG. 4, the fourth global navigation object 406 displayed in this exemplary embodiment is a live TV global navigation object. Actuation of the global navigation object 406 results in the user interface immediately displaying a live TV UI view that enables a user to quickly view television programming from virtually any UI view within the interface. An example of a live TV UI view 700 is shown in FIG. 7, wherein it can be seen that the entire interface area has been cleared out of UI objects so that the user has an unimpeded view of the live television programming. A channel selection control overlay 800 (FIG. 8) can be displayed, and used to change channels, in response to movement of the cursor proximate to the leftmost region of the user interface. Similarly a volume control overlay 900 (FIG. 9) can be displayed, and used to change the output volume of the television, in response to movement of the cursor proximate to the rightmost region of the user interface. More information relating to the operation of the channel selection control overlay 800 and volume control overlay 900 can be found in the above-incorporated by reference U.S. patent application entitled “METHODS AND SYSTEMS FOR SCROLLING AND POINTING IN USER INTERFACE”, to Frank J. Wroblewski.

Comparing FIGS. 7, 8 and 9 reveals that the global navigation objects 324 are visible in the UI view 700, but not in the UI views 800 and 900. This visual comparison introduces the different display states of global navigation objects according to exemplary embodiments of the present invention. More specifically, according to one exemplary embodiment of the present invention, the global navigation objects 324 can be displayed in one of three display states: a watermark state, an over state and a non-displayed state. In their watermark (partially visible) state, which is a default display state, each of the global navigation 324 are displayed in a manner so as to be substantially transparent (or faintly filled in) relative to the rest of the UI objects in a given UI view. For example, the global navigation objects can be displayed only as a faint outline of their corresponding icons when in their watermark state. As the default display state, this enables the global navigation objects 324 to be sufficiently visible for the user to be aware of their location and functionality, but without taking the focus away from the substantially opaque UI objects which represent selectable media items.

In their over display state, which is triggered by the presence of a cursor proximate and/or over one of the global navigation objects 324, that global navigation object has its outline filled in to become opaque. Once in its over display state, the corresponding global navigation object 400-406 can be actuated, e.g., by a button click of the 3D pointing device 300.

Lastly, for at least some UI views, the global navigation objects 324 can also have a non-displayed state, wherein the global navigation objects 324 become completely invisible. This non-displayed state can be used, for example, in UI views such as the live TV view 700 where it is desirable for the UI objects which operate as controls to overlay the live TV feed only when the user wants to use those controls. This can be implemented by, for example, having the global navigation objects 324 move from their watermark display state to their non-displayed state after a predetermined amount of time has elapsed without input to the user interface from the user while a predetermined UI view is currently being displayed. Thus, if the live TV view 700 is currently being displayed on the television and the user interface does not receive any input, e.g., motion of the 3D pointing device 300, for more than 3 or 5 seconds, then the global navigation objects 324 can be removed from the display.

Global navigation objects 324 may have other attributes according to exemplary embodiments of the present invention, including the number of global navigation objects, their location as a group on the display, their location as individual objects within the group and their effects. Regarding the former attribute, the total number of global navigation objects should be minimized to provide needed short-cut functionality, but without obscuring the primary objectives of the user interface, e.g., access to media items, or overly complicating the interface so that the user can learn the interface and form navigation habits which facilitate quick and easy navigation among the media items. Thus according to various exemplary embodiments of the present invention, the number of global navigation objects 324 provided on any one UI view may be 1, 2, 3, 4, 5, 6 or 7 but preferably not more than 7 global navigation objects will be provided to any given user interface. The previously discussed and illustrated exemplary embodiments illustrate the global navigation objects 324 being generally centered along a horizontal axis of the user interface and proximate a top portion thereof, however other exemplary embodiments of the present invention may render the global navigation objects in other locations, e.g., the upper righthand or lefthand corners of the user interface. Whichever portion of the user interface is designated for display of the global navigation buttons, that portion of the user interface should be reserved for such use, i.e., such that the other UI objects are not selectable within the portion of the user interface which is reserved for the global navigation objects 324.

Additionally, location of individual global navigation objects 324 within the group of global navigation objects, regardless of where the group as a whole is positioned on the display, can be specified based on, e.g., frequency of usage. For example, it may be easier for users to accurately point to global navigation objects 324 at the beginning or end of a row that those global navigation objects in the middle of the row. Thus the global navigation objects 324 which are anticipated to be most frequently used, e.g., the home and live TV global navigation objects in the above-described examples, can be placed at the beginning and end of the row of global navigation objects 324 in the exemplary embodiment of FIG. 4.

According to some exemplary embodiments of the present invention, global navigation objects can have other characteristics regarding their placement throughout the user interface. According to one exemplary embodiment, the entire set of global navigation objects are displayed, at least initially, on each and every UI view which is available in a user interface (albeit the global navigation objects may acquire their non-displayed state on at least some of those UI views as described above). This provides a consistency to the user interface which facilitates navigation through large collections of UI objects. On the other hand, according to other exemplary embodiments, there may be some UI views on which global navigation objects are not displayed at all, such that the user interface as a whole will only have global navigation objects displayed on substantially every UI view in the user interface.

Likewise, it is generally preferable that, for each UI view in which the global navigation objects are displayed, they be displayed in an identical manner, e.g., the same group of global navigation objects, the same images/text/icons used to represent each global navigation function, the same group location, the same order within the group, etc. However there may be some circumstances wherein, for example, the functional nature of the user interface suggests a slight variance to this rule, e.g., wherein one or more global navigation objects are permitted to vary based on a context of the UI view in which it is displayed. For example, for a UI view where direct access to live TV is already available, the live TV global navigation object 406 can be replaced or removed completely. In the above-described exemplary embodiment this can occur when, for example, a user zooms-in on the application entitled “Guide” in FIG. 3(b). This action results in the user interface displaying an electronic program guide, such as that shown in FIG. 10, on the television (or other display device). Note that from the UI view of FIG. 10, a user can directly reach a live TV UI view in a number of different ways, e.g., by positioning a cursor over the scaled down, live video display 1000 and zooming in or by positioning a cursor over a program listing within the grid guide itself and zooming in. Since the user already has direct access to live TV from the UI view of FIG. 10, the live TV global navigation object 406 can be replaced by a DVR global navigation object 1002 which enables a user to have direct access to a DVR UI view. Similarly, the live TV global navigation object 406 for the live TV UI views (e.g., that of FIG. 7) can be replaced by a guide global navigation object which provides the user with a short-cut to the electronic program guide. For those exemplary embodiments of the present invention wherein one or more global navigation objects are permitted to vary from UI view to UI view based on context, it is envisioned that there still will be a subset of the global navigation objects which will be the same for each UI view on which global navigation objects are displayed. In the foregoing examples, a subset of three of the global navigation objects (e.g., those associated with home, up and search functions) are displayed identically (or substantially identically) and provide an identical function on each of the UI views on which they are displayed, while one of the global navigation objects (i.e., the live TV global navigation object) is permitted to change for some UI views.

Still another feature of global navigation objects according to some exemplary embodiments of the present invention is the manner in which they are handled during transition from one UI view to another UI view. For example, as mentioned above some user interfaces according to exemplary embodiments of the present invention employ zooming and/or panning animations to convey a sense of position change within a “Zuiverse” of UI objects as a user navigates between UI views. However, according to some exemplary embodiments of the present invention, the global navigation objects are exempt from these transition effects. That is, the global navigation objects do not zoom, pan or translate and are, instead, fixed in their originally displayed position while the remaining UI objects shift from, e.g., a zoomed-out view to a zoomed-in view. This enables user interfaces to, on the one hand, provide the global navigation objects as visual anchors, while, on the other hand, not detract from conveying the desired sense of movement within the user interface by virtue of having the global navigation buttons in their default watermark (transparent) state.

Systems and methods for processing data according to exemplary embodiments of the present invention can be performed by one or more processors executing sequences of instructions contained in a memory device. Such instructions may be read into the memory device from other computer-readable mediums such as secondary data storage device(s). Execution of the sequences of instructions contained in the memory device causes the processor to operate, for example, as described above. In alternative embodiments, hard-wire circuitry may be used in place of or in combination with software instructions to implement the present invention.

Numerous variations of the afore-described exemplary embodiments are contemplated. The above-described exemplary embodiments are intended to be illustrative in all respects, rather than restrictive, of the present invention. Thus the present invention is capable of many variations in detailed implementation that can be derived from the description contained herein by a person skilled in the art. All such variations and modifications are considered to be within the scope and spirit of the present invention as defined by the following claims. No element, act, or instruction used in the description of the present application should be construed as critical or essential to the invention unless explicitly described as such. Also, used herein, the article “a” is intended to include one or more items.

1. A user interface for manipulating media items on a television comprising:
a plurality of different user interface (UI) views, each of which can be displayed on said television;
wherein each of said plurality of different UI views displays a different set of UI objects associated with said media items, which UI objects can be selected by user interaction with said user interface; and
a plurality of global navigation objects, at least a subset of which are substantially identically displayed on substantially every UI view displayed by said user interface;
wherein each of said plurality of global navigation objects have at least three display states: a watermark state, an over state and a non-displayed state;
wherein in said watermark state, which is a default display state, each of said global navigation objects are displayed to be partially visible;
wherein in said over state, which is triggered by presence of a cursor proximate or over one of said global navigation objects, said one of said global navigation objects becomes fully visible; and
wherein in said non-displayed state, said global navigation objects are removed from display in a current UI view.

2. The user interface of claim 1, wherein said plurality of global navigation objects consist of four global navigation objects displayed in a portion of said user interface which is reserved for display of said global navigation objects such that said UI objects are not selectable within said portion of said user interface.

3. The user interface of claim 2, wherein said subset of said plurality of global navigation objects consists of three global navigation objects which are identically displayed on every UI view displayed by said user interface and wherein a fourth of said plurality of global navigation objects may vary from UI view to UI view.

4. The user interface of claim 3, wherein said three global navigation objects which are identically displayed on every UI view are a home global navigation object, an up global navigation object and a search global navigation object and wherein:
(a) actuation of said home global navigation object from any of said UI views results in a home view of said user interface being displayed;
(b) actuation of said up global navigation object from any of said UI views results in said user interface zooming out to a next highest zoom level relative to a currently displayed UI view;
(c) actuation of said search global navigation object from any of said UI views results in search tool being displayed on said user interface.

5. The user interface of claim 4, wherein said search tool enables a user to search for one of said media items using both keyword and visual browsing search techniques.

6. The user interface of claim 1, wherein said user interface has a UI view from which a user can watch live television programming and further wherein said global navigation objects enter said non-displayed state a predetermined time period after said user interface displays said UI view from which said user can watch said live television programming.

7. The user interface of claim 6, wherein said predetermined time period is more than three seconds of motionlessness of a remote control device associated with providing input to said user interface.

8. The user interface of claim 1, wherein one of said plurality of global navigation objects may vary from UI view to UI view.

9. The user interface of claim 8, wherein said one of said plurality of global navigation objects is a live TV global navigation object when displayed on a majority of said plurality of different UI views; and
further wherein actuation of said live TV global navigation object results in said user interface immediately displaying a UI view wherein a user can watch live television programming.

10. The user interface of claim 9, wherein said one of said plurality of global navigation objects changes from a live TV global navigation object to an electronic program guide global navigation object when said user interface displays said UI view wherein said user can watch live television programming, and further wherein actuation of said electronic program guide global navigation object from said UI view wherein said user can watch live television programming results in a display of an electronic program guide on said user interface.

11. The user interface of claim 9, wherein said one of said plurality of global navigation objects changes from a live TV global navigation object to a digital video recorder (DVR) global navigation object when said user interface displays a UI view associated with an electronic program guide and further wherein actuation of said DVR global navigation object from said electronic program guide results in a display of a DVR view on said user interface.

12. The user interface of claim 4, wherein said actuation of said up global navigation object from any of said UI views results in said user interface zooming out to a next highest zoom level relative to a currently displayed UI view by progressive scaling and displaying of at least some of said UI objects displayed in a current UI view that gives the visual impression of movement of said at least some of said UI objects away from an observer.

13. The user interface of claim 1, wherein said user interface transitions from one of said plurality of different UI views to another of said UI views by zooming, wherein said zooming is performed by progressive scaling and displaying of at least some of said UI objects displayed said one of said plurality of different UI views that gives the visual impression of movement of said at least some of said UI objects toward, or away from, an observer; and
further wherein said plurality of global navigation buttons do not zoom with said at least some of said UI objects during said transition.

14. The user interface of claim 1, wherein said user interface transitions from one of said plurality of different UI views to another of said UI views by panning, wherein said panning is performed by progressive translating and displaying of at least some of said UI objects displayed said one of said plurality of different UI views that gives the visual impression of lateral movement of said at least some of said UI objects; and
further wherein said plurality of global navigation buttons do not pan with said at least some of said UI objects during said transition.

15. The user interface of claim 1, wherein said media items include at least one of: photos, video-on-demand, live television programming, music, shopping items, and pre-recorded video.

16. The user interface of claim 1, wherein said plurality of global navigation objects number at most five.

17. The user interface of claim 1, wherein all of said plurality of global navigation objects are identically displayed in each state thereof on every UI view displayed by said user interface.

18-19. (canceled)

20. A method for displaying media items in a user interface comprising the steps of:
displaying a plurality of different user interface (UI) views;
wherein each of said plurality of different UI views displays a different set of UI objects associated with said media items, which UI objects can be selected by user interaction with said user interface; and
displaying a plurality of global navigation objects, at least a subset of which are substantially identically displayed on substantially every UI view displayed by said user interface;
wherein each of said plurality of global navigation objects have at least three display states: a watermark state, an over state and a non-displayed state;
wherein in said watermark state, which is a default display state, each of said global navigation objects are displayed to be partially visible;
wherein in said over state, which is triggered by presence of a cursor proximate or over one of said global navigation objects, said one of said global navigation objects becomes fully visible; and
wherein in said non-displayed state, said global navigation objects are removed from display in a current UI view.

21. The method of claim 20, wherein said plurality of global navigation objects consist of four global navigation objects displayed in a portion of said user interface which is reserved for display of said global navigation objects such that said UI objects are not selectable within said portion of said user interface.

22. The method of claim 21, wherein said subset of said plurality of global navigation objects consists of three global navigation objects which are identically displayed on every UI view displayed by said user interface and wherein a fourth of said plurality of global navigation objects may vary from UI view to UI view.

23. The method of claim 22, wherein said three global navigation objects which are identically displayed on every UI view are a home global navigation object, an up global navigation object and a search global navigation object and wherein:
(a) actuation of said home global navigation object from any of said UI views results in a home view of said user interface being displayed;
(b) actuation of said up global navigation object from any of said UI views results in said user interface zooming out to a next highest zoom level relative to a currently displayed UI view;
(c) actuation of said search global navigation object from any of said UI views results in search tool being displayed on said user interface.

24. The method of claim 23, wherein said search tool enables a user to search for one of said media items using both keyword and visual browsing search techniques.

25. The method of claim 20, wherein said user interface has a UI view from which a user can watch live television programming and further wherein said global navigation objects enter said non-displayed state a predetermined time period after said user interface displays said UI view from which said user can watch said live television programming.

26. The method of claim 25, wherein said predetermined time period is more than three seconds of motionlessness of a remote control device associated with providing input to said user interface.

27. The method of claim 20, wherein one of said plurality of global navigation objects may vary from UI view to UI view.

28. The method of claim 27, wherein said one of said plurality of global navigation objects is a live TV global navigation object when displayed on a majority of said plurality of different UI views; and
further wherein actuation of said live TV global navigation object results in said user interface immediately displaying a UI view wherein a user can watch live television programming.

29. The method of claim 28, wherein said one of said plurality of global navigation objects changes from a live TV global navigation object to an electronic program guide global navigation object when said user interface displays said UI view wherein said user can watch live television programming, and further wherein actuation of said electronic program guide global navigation object from said UI view wherein said user can watch live television programming results in a display of an electronic program guide on said user interface.

30. The method of claim 28, wherein said one of said plurality of global navigation objects changes from a live TV global navigation object to a digital video recorder (DVR) global navigation object when said user interface displays a UI view associated with an electronic program guide and further wherein actuation of said DVR global navigation object from said electronic program guide results in a display of a DVR view on said user interface.

31. The method of claim 23, wherein said actuation of said up global navigation object from any of said UI views results in said user interface zooming out to a next highest zoom level relative to a currently displayed UI view by progressive scaling and displaying of at least some of said UI objects displayed in a current UI view that gives the visual impression of movement of said at least some of said UI objects away from an observer.

32. The method of claim 20, wherein said user interface transitions from one of said plurality of different UI views to another of said UI views by zooming, wherein said zooming is performed by progressive scaling and displaying of at least some of said UI objects displayed said one of said plurality of different UI views that gives the visual impression of movement of said at least some of said UI objects toward, or away from, an observer; and
further wherein said plurality of global navigation buttons do not zoom with said at least some of said UI objects during said transition.

33. The method of claim 20, wherein said user interface transitions from one of said plurality of different UI views to another of said UI views by panning, wherein said panning is performed by progressive translating and displaying of at least some of said UI objects displayed said one of said plurality of different UI views that gives the visual impression of lateral movement of said at least some of said UI objects; and
further wherein said plurality of global navigation buttons do not pan with said at least some of said UI objects during said transition.

34. The method of claim 20, wherein said media items include at least one of: photos, video-on-demand, live television programming, music, shopping items, and pre-recorded video.

35. The method of claim 20, wherein said plurality of global navigation objects number at most five.

36. The method of claim 20, wherein all of said plurality of global navigation objects are identically displayed in each state thereof on every UI view displayed by said user interface.
